(19) United States
(12) Patent Application Publication
(10) Pub. No.: US 2026/0002795 A1
(43) Pub. Date: Jan. 1, 2026

(54) STORAGE MEDIUM, COMMUNICATION DEVICE, AND METHOD OF CONTROLLING COMMUNICATION DEVICE

(71) Applicant: HONDA MOTOR CO., LTD., Tokyo (JP)

(72) Inventors: Katsumi SHIMIZU, Tokyo (JP); Kento UEMURA, Tokyo (JP)

(21) Appl. No.: 19/244,476

(22) Filed: Jun. 20, 2025

(30) Foreign Application Priority Data
Jun. 28, 2024 (JP) 2024-105420

(51) Int. Cl. G01C 25/00; G07C 5/00; G07C 5/04

(52) U.S. Cl. CPC G01C 25/005; G07C 5/008; G07C 5/04

(57) ABSTRACT

A non-transitory computer-readable storage medium storing a program causing a computer of a communication device to perform: acquiring speed information of a vehicle; receiving an acceleration measurement start instruction for an acceleration sensor of the communication device; in a case where the measurement start instruction is received and the vehicle stops, executing calibration of the acceleration sensor in response to elapse of a first set time in a stopped state from when the vehicle stops; storing a result of the calibration; and reflecting the result of the calibration stored in response to elapse of a second set time in the stopped state from when the vehicle stops.

### CROSS-REFERENCE TO RELATED APPLICATION(S)

This application claims priority to and the benefit of Japanese Patent Application No. 2024-105420, filed Jun. 28, 2024, the entire disclosure of which is incorporated herein by reference.

### BACKGROUND OF THE INVENTION

### Field of the Invention

The present invention relates to a storage medium, a communication device, and a method of controlling a communication device.

### Description of the Related Art

Conventionally, for example, an acceleration sensor of a smartphone is used to measure driving behavior when a user of the smartphone drives a vehicle, calculate a driving score from a history of a change in acceleration or the like, and present the driving score to the user. This acceleration sensor needs to be calibrated in order to reduce a measurement error.

Japanese Patent No. 6684393 discloses a three-axis acceleration sensor of a mobile terminal, determining acceleration caused by sudden braking of a vehicle, and determining a traveling direction of the vehicle in a case where acceleration caused by sudden braking occurs. In addition, Japanese Patent No. 6684393 discloses a calibration method of determining the traveling direction of the vehicle from a result of sudden braking and detecting acceleration along the traveling direction of the vehicle even when the acceleration sensor is not attached to be aligned with the traveling direction of the vehicle.

However, the technique described in Japanese Patent No. 6684393 has a problem that it is necessary to consciously generate sudden braking for calibration, and it takes time and effort for calibration.

### SUMMARY OF THE INVENTION

The present invention has been made in view of the above problems, and provides a technique of calibrating an acceleration sensor of a communication device without user's consciousness when measuring driving behavior using the acceleration sensor.

According to one aspect of the present invention, there is provided a non-transitory computer-readable storage medium storing a program causing a computer of a communication device to perform:
acquiring speed information of a vehicle;
receiving an acceleration measurement start instruction for an acceleration sensor of the communication device;
in a case where the measurement start instruction is received and the vehicle stops, executing calibration of the acceleration sensor in response to elapse of a first set time in a stopped state from when the vehicle stops;
storing a result of the calibration; and
reflecting the result of the calibration stored in response to elapse of a second set time in the stopped state from when the vehicle stops.

### BRIEF DESCRIPTION OF THE DRAWINGS

FIG. 1 is a diagram illustrating a configuration example of a communication system according to one embodiment;

FIG. 2 is a diagram illustrating a hardware configuration example of a server apparatus according to one embodiment;

FIG. 3 is a diagram illustrating a hardware configuration example of a vehicle according to one embodiment;

FIG. 4 is a diagram illustrating a hardware configuration example of a communication device according to one embodiment;

FIG. 5 is a flowchart illustrating a procedure of processing performed by the communication device according to one embodiment; and

FIG. 6 is an explanatory diagram of processing according to one embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

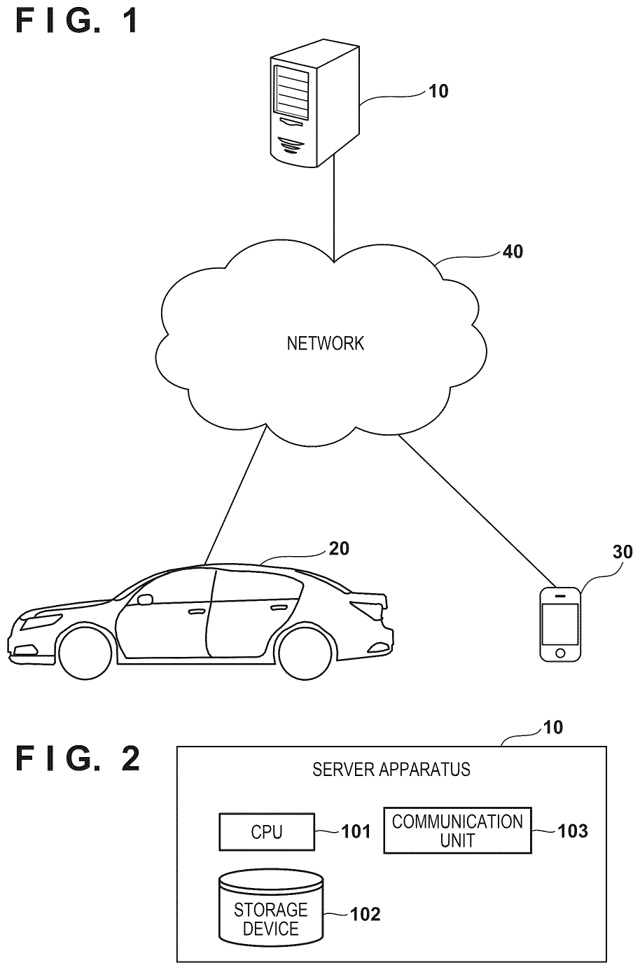

FIG. 1 is a diagram illustrating a configuration example of a communication system according to the present embodiment. In FIG. 1, reference numeral 10 denotes a server apparatus (an information processing apparatus). Reference numeral 20 denotes a vehicle. Reference numeral 30 denotes a communication device, for example, a smartphone. The communication device is not limited to the smartphone, and may be other types of communication devices such as a tablet terminal and a head-mounted display. Reference numeral 40 denotes a network, and the individual devices are connected via the network 40. The vehicle 20 and the communication device 30 may be communicable using near field communication.

### Device Configuration

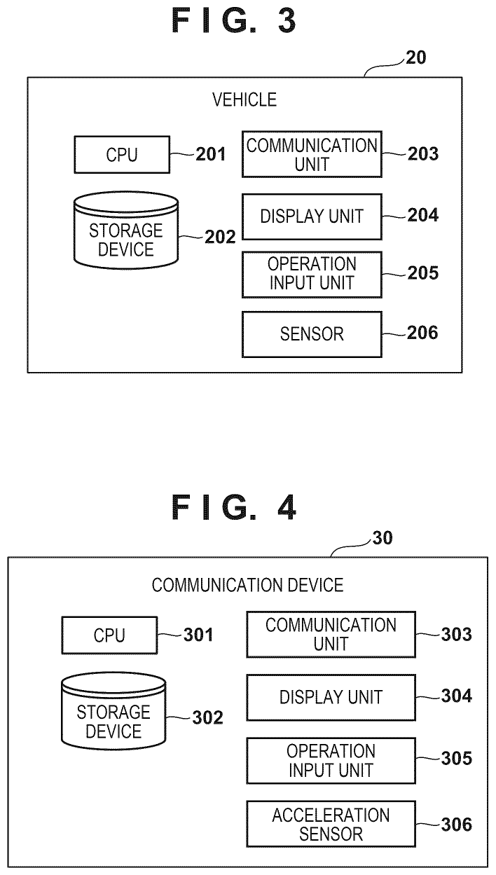

Next, configuration examples of the server apparatus 10, the vehicle 20, and the communication device 30 according to one embodiment of the present invention will be described with reference to FIGS. 2, 3, and 4. FIG. 2 is a diagram illustrating a configuration example of the server apparatus 10 according to one embodiment of the present invention, FIG. 3 is a diagram illustrating a configuration example of the vehicle 20 according to one embodiment of the present invention, and FIG. 4 is a diagram illustrating a configuration example of the communication device 30 according to one embodiment of the present invention.

As illustrated in FIG. 2, the server apparatus 10 includes a CPU 101, a storage device 102, and a communication unit 103. A control operation of the server apparatus 10 is achieved by the CPU 101 reading and executing a computer program stored in the storage device 102. The CPU 101 may be one or more CPUs. The storage device 102 is one or more memories that store several types of information. For example, information that has been received from another device, a computer program to be read and executed by the CPU 101, and the like are stored. The communication unit 103 has a function of communicating with another device in a wired or wireless manner through the network 40.

As illustrated in FIG. 3, the vehicle 20 includes a CPU 201, a storage device 202, a communication unit 203, a display unit 204, an operation input unit 205, and a sensor 206. A control operation of the vehicle 20 is achieved by the CPU 201 reading and executing a computer program stored in the storage device 202. The CPU 201 may be one or more CPUs. The storage device 202 is one or more memories that store several types of information. For example, information that has been received from another device, a computer program to be read and executed by the CPU 201, and the like are stored. The communication unit 203 has a function of communicating with another device in a wired or wireless manner through the network 40. Furthermore, the communication unit 203 can also communicate with a nearby device by near field communication. The communication unit 203 receives GPS signals from a plurality of satellites using, for example, a global positioning system (GPS) receiver provided in the vehicle 20, and specifies the position of the vehicle 20 on the basis of the reception results. The CPU 201 can calculate the traveling speed of the vehicle 20 using the GPS signal.

The display unit 204 is a liquid crystal display or the like, and displays various types of information. The operation input unit 205 is, for example, a mouse, a keyboard, a touch panel, a switch, or the like, and can receive input of various types of information from the user. The sensor 206 can include various sensors such as a vehicle speed sensor and an acceleration sensor. Information of the traveling speed of the vehicle 20 can be acquired by the vehicle speed sensor, and information of the acceleration of the vehicle 20 can be acquired by the acceleration sensor.

As illustrated in FIG. 4, the communication device 30 includes a CPU 301, a storage device 302, a communication unit 303, a display unit 304, an operation input unit 305, and an acceleration sensor 306. A control operation of the communication device 30 is achieved by the CPU 301 reading and executing a computer program stored in the storage device 302. The CPU 301 may be one or more CPUs. The storage device 302 is one or more memories that store several types of information. For example, information that has been received from another device, a computer program to be read and executed by the CPU 301, and the like are stored. The communication unit 303 has a function of communicating with another device in a wired or wireless manner through the network 40. Furthermore, the communication unit 303 can also communicate with a nearby device by near field communication.

The communication unit 303 receives GPS signals from a plurality of satellites using, for example, a global positioning system (GPS) receiver provided in the communication device 30, and specifies the position of the communication device 30 on the basis of the reception results. The CPU 301 can calculate the moving speed of the communication device 30 using the GPS signal. The display unit 204 is a liquid crystal display or the like, and displays various types of information. The operation input unit 205 is, for example, a mouse, a keyboard, a touch panel, a switch, or the like, and can receive input of various types of information from the user. The acceleration sensor 306 is, for example, a three-axis acceleration sensor, and detects the acceleration of the communication device 30.

### Processing

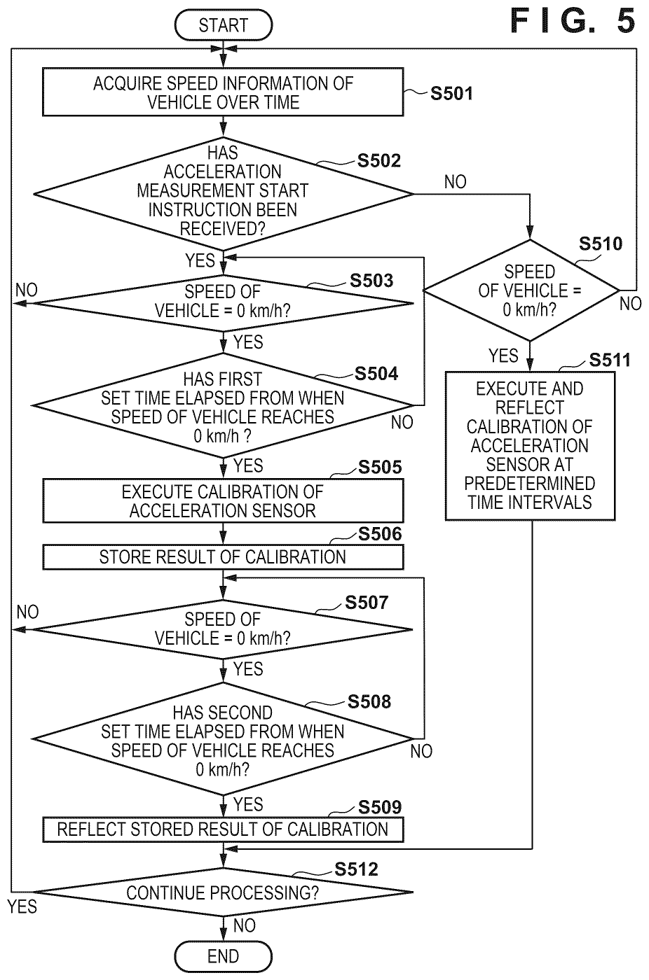

Next, a procedure of processing performed by the communication device 30 according to the present embodiment will be described with reference to a flowchart of FIG. 5. In the present embodiment, a situation is assumed in which, when a user possessing the communication device 30 gets on the vehicle 20 and drives, the user intends to measure the user's driving behavior (driving score) from a change in acceleration of the communication device 30 using a driving behavior measuring application installed in the communication device 30. By measuring the acceleration, in a case where there is a rapid change in acceleration (sudden start or sudden braking), the driving score becomes low, and thus it is possible to know the tendency of own driving and to urge improvement so that safer driving can be performed. In the present embodiment, an example in which the calibration of the acceleration sensor is executed when such an application for measuring the driving score is used will be described.

In S501, the communication device 30 acquires speed information of the vehicle 20. In the present embodiment, the communication device 30 acquires a GPS signal via a GPS receiver provided in the communication device 30 and acquires position information of the communication device 30. The communication device 30 then calculates the moving speed of the communication device 30 from the temporal change in the position information of the communication device 30. Since the communication device 30 is present in the vehicle 20, the moving speed of the communication device 30 is the same as the traveling speed of the vehicle 20. Therefore, the communication device 30 can acquire the calculated moving speed of the communication device 30 as the speed information of the vehicle 20. The speed information of the vehicle 20 continues to be acquired over time (for example, periodically).

Alternatively, the vehicle 20 may acquire a GPS signal via a GPS receiver provided in the vehicle 20 to acquire position information of the vehicle 20, and the vehicle 20 may calculate the traveling speed of the vehicle 20 from the temporal change in its own position information. In this case, in S501, the communication device 30 may acquire the speed information of the vehicle 20 by receiving the information of the traveling speed of the vehicle 20 acquired in the vehicle 20 directly from the vehicle 20 or via the server apparatus 10.

In S502, the communication device 30 determines whether or not an acceleration measurement start instruction is received via the operation input unit 305. For example, a graphical user interface (GUI) button for receiving a measurement start instruction is displayed on the display screen of the display unit 304 in the communication device 30, and input of the measurement start instruction can be received from the user. The process of this step is a process of determining whether or not the GUI button has already been pressed at this timing.

Here, the measurement start instruction is an instruction to start measurement of driving behavior (driving score) using the acceleration sensor 306. For example, a start button for starting the measurement of the driving score may be displayed, and the input of the start instruction may be received in response to the user touching the start button. In addition, the measurement is ended in response to the pressing of a measurement end button, and the driving score can be calculated on the basis of the change in acceleration during driving and displayed to the user. For example, if there are many times of sudden acceleration, sudden braking, and the like, the driving score is calculated to be low, and otherwise, the driving score is calculated to be high. In a case where the determination in this step is Yes, the processing proceeds to S503. On the other hand, in a case where the determination in this step is No, the processing proceeds to S510.

In S503, the communication device 30 determines whether or not the vehicle is stopped (the speed of the vehicle 20 is 0 km/h). In a case where the determination in this step is Yes, the processing proceeds to S504. On the other hand, in a case where the determination in this step is No, the processing returns to S501.

In S504, the communication device 30 determines whether or not a first set time (for example, three seconds) has elapsed in a stopped state from when the speed of the vehicle 20 reaches 0 km/h. In a case where the speed of the vehicle 20 is higher than 0 km/h (that is, the vehicle 20 is moving) at the time when the measurement start instruction is received, the time is counted from when the speed of the vehicle 20 reaches 0 km/h (from when the vehicle 20 stops). On the other hand, in a case where the speed of the vehicle 20 is 0 km/h (that is, the vehicle 20 is stopped) at the time when the measurement start instruction is received, the time is counted from the time when the measurement start instruction is received. In a case where the determination in this step is Yes, the processing proceeds to S505. On the other hand, in a case where the determination in this step is No, the processing returns to S503.

In S505, the communication device 30 executes the calibration of the acceleration sensor 306. In the present embodiment, calibration is executed for all the axes of a three-axis acceleration sensor. Even in a case where the vehicle is traveling with the communication device 30 fixed at a specific position (for example, a smartphone holder) inside the vehicle 20, the position of the communication device 30 may be slightly shifted by the vehicle traveling on a curved road or a poor conditioned road, for example. When the vehicle 20 stops, the communication device 30 executes calibration for all the three axes at the shifted position and uses the calibration result as a reference, so that it is possible to reduce the measurement error of the acceleration and to accurately measure the driving behavior during traveling after the stop.

In S506, the communication device 30 stores the result of calibration executed in S505. At this point, the calibration result is not reflected.

In S507, the communication device 30 determines whether or not the vehicle is stopped (the speed of the vehicle 20 is 0 km/h). In a case where the determination in this step is Yes, the processing proceeds to S508. On the other hand, in a case where the determination in this step is No, the processing returns to S501.

In S508, it is determined whether or not a second set time (for example, five seconds) has elapsed in the stopped state from when the speed of the vehicle 20 reaches 0 km/h. In a case where the determination in this step is Yes, the processing proceeds to S509. On the other hand, in a case where the determination in this step is No, the processing proceeds to S507.

In S509, the communication device 30 reflects the calibration result stored in S506 in the acceleration sensor 306. Thereafter, the processing proceeds to S512.

In S510, the communication device 30 determines whether or not the vehicle is stopped (the speed of the vehicle 20 is 0 km/h). In a case where the determination in this step is Yes, the processing proceeds to S511. On the other hand, in a case where the determination in this step is No, the processing returns to S501.

In S511, the communication device 30 executes the calibration of the acceleration sensor 306 at predetermined time intervals (for example, at intervals of three seconds), and immediately reflects the calibration result. The process of S511 is a process performed in a case where the vehicle 20 is stopped before the measurement start instruction is received, and in such a case, the calibration is periodically executed and reflected. Thereafter, the processing proceeds to S512.

In step S512, the communication device 30 determines whether or not to continue the processing. For example, in a case where the application being activated in the communication device 30 is closed or in a case where an instruction to stop the measurement is received, the processing ends. In a case where the determination in this step is Yes, the processing returns to S501. On the other hand, in a case where the determination in this step is No, the processing ends.

Note that the order of the processes in the flowchart is not limited to the described order, and may have another order. In addition, any other processes may be appropriately added, or some processes may be excluded.

### Application Scene

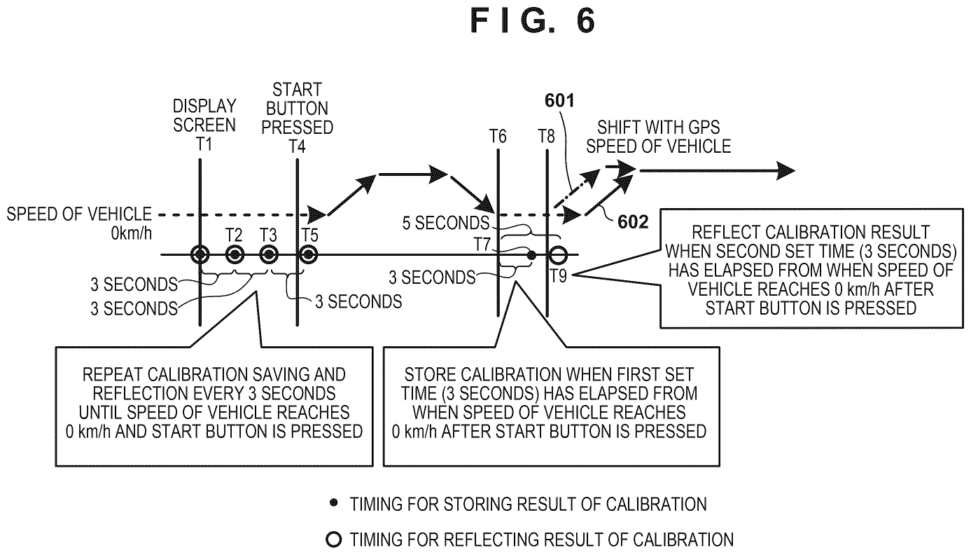

Next, a part of the processing in accordance with the flowchart of FIG. 5 will be described with reference to FIG. 6. It is assumed that the vehicle 20 is in a stopped state (vehicle speed is 0 km/h) from when the screen of the application for measuring the driving behavior is displayed (T1) to when the measurement start instruction is received (before the start button is pressed) (T4). In this case, No in S502 and Yes in S510, and in S511, the calibration of the acceleration sensor is executed at predetermined time intervals, and the storage and reflection of the calibration result are performed at the same timing.

In the illustrated example, at T1, the calibration result is stored and reflected at the same time. That is, the sensor value of the acceleration sensor 306 is immediately reflected for calibration.

Thereafter, at predetermined time intervals (for example, intervals of three seconds), for example, at T2, T3, and T5, the sensor value of the acceleration sensor 306 is immediately reflected for calibration. That is, the calibration result is performed, stored, and reflected at the same time. The processing of repeating the execution of the calibration, and the storage and reflection of the calibration result is performed every three seconds until the speed of the vehicle 20 is 0 km/h and the measurement start instruction is received. Since it is predicted that the user operates the communication device 30 until the vehicle 20 starts traveling, the calibration is repeated as much as possible. Here, it is assumed that the measurement start instruction is received at T4. In this case, since the calibration is already being executed at the time (T4) when the measurement start instruction is received, continuation of the calibration processing is prioritized, and the processing in which the calibration result is stored and reflected at the same time may be completed at T5. That is, when calibration at predetermined time intervals is being executed at the time when the measurement start instruction is received, completion of the execution of the calibration may be prioritized. In this case, the acceleration measurement for measuring the driving behavior may be started after the calibration is completed.

Subsequently, after T5 in the illustrated example, the vehicle 20 starts and the speed of the vehicle 20 increases, maintains the same speed, and then decreases and stops (T6). For example, a situation in which the vehicle starts, and stops before the next traffic signal corresponds to this situation. After the measurement start instruction is received (T4), the speed of the vehicle 20 is 0 km/h at T6. Thereafter, the first set time has elapsed from T6 at T7. Therefore, the sensor value of the acceleration sensor 306 is stored for calibration at T7. That is, the calibration is executed and the calibration result is stored. Thereafter, the second set time (for example, 5 seconds) has elapsed from T6 at T9. Therefore, at T9, the calibration result (the stored sensor value of the acceleration sensor 306) is reflected. In this case, Yes is determined in S502, Yes is determined in S503, Yes is determined in S504, the processing proceeds to S505 and S506, Yes is determined in S507, Yes is determined in S508, the processing proceeds to S509, and each process is performed.

Here, a time lag may occur between the reception of a GPS signal and the calculation of the speed of the vehicle 20 on the basis of the GPS signal. Due to such an error, there is a possibility that it is erroneously determined that the speed of the vehicle 20 is 0 km/h although the vehicle 20 actually starts traveling. For example, as illustrated in FIG. 6, although a calculated (acquired) speed 602 of the vehicle 20 is zero at T9, an actual speed 601 of the vehicle 20 may not be zero (vehicle starts). As a result, there is a possibility that inappropriate calibration is executed assuming that the result of the calibration executed at the time of traveling is the result of the calibration executed at the time of stopping.

In view of such a time lag of the GPS signal and the like, if the calculated (acquired) speed of the vehicle 20 is zero at T9 (the time when the second set time has elapsed), it is considered that the actual speed of the vehicle 20 is also zero at the time (T7) that is a certain time before T9 (before T9 by a difference between the second set time and the first set time). That is, in a case where the speed of the vehicle 20 is zero at T9, it can be estimated that the speed of the vehicle 20 is also zero even at T7 which is a predetermined time (2 seconds) before T9.

Therefore, in response to the elapse of the first set time in the stopped state from when the vehicle 20 stops, the calibration of the acceleration sensor is executed and the calibration result is stored. If it can be confirmed that the second set time has elapsed in the stopped state, it can be confirmed that the stored calibration result is the result of the calibration executed in a state where the vehicle 20 actually stops. Therefore, since it can be found that the calibration result at the time when the first set time has elapsed is an appropriate result only at the time when the second set time has elapsed, the stored result is reflected at the time when the second set time has elapsed. As a result, it is possible to suppress erroneous calibration.

As described above, in the present embodiment, in response to the elapse of the first set time in the stopped state from when the vehicle 20 stops, the calibration of the acceleration sensor is executed and the calibration result is stored. The stored calibration result is reflected in response to the elapse of the second set time in the stopped state.

As a result, when driving behavior is measured using the acceleration sensor of the communication device, it is possible to automatically execute the calibration of the acceleration sensor without user's consciousness. In addition, since the result of the calibration executed when the vehicle is reliably stopped can be reflected, it is possible to reduce the measurement error of the acceleration at the time of measuring the driving behavior.

### [Modifications]

In the above embodiment, an example in which the first set time is three seconds and the second set time is five seconds has been described, but the individual values are not limited thereto. The first set time may be a value in the range of about 3 to 10 seconds, and the second set time may be a value in the range of the first set time+a predetermined time (about two seconds), that is, about 5 to 12 seconds.

In the above embodiment, an example has been described in which the stored calibration result is reflected in response to the elapse of the second set time in the stopped state from when the vehicle 20 stops, but it is not limited thereto. The stored calibration result may be reflected in response to the elapse of the predetermined time in the stopped state from the elapse of the first set time.

More specifically, similarly to the embodiment described above, first, in a case where the measurement start instruction is received and the vehicle 20 stops, the calibration of the acceleration sensor 306 is executed and the calibration result is stored in response to the elapse of the first set time (for example, three seconds) in the stopped state from when the vehicle 20 stops. As a modification, the stored calibration result may be reflected in response to the elapse of a predetermined time (for example, two seconds) in the stopped state of the vehicle 20 from the elapse of the first set time.

In the above embodiment, an example in which the calibration is executed when the vehicle 20 stops by a traffic signal or the like has been described, but control may be executed such that the calibration is executed once when the vehicle stops once. That is, after the measurement start instruction is received, the calibration may be executed once and reflected every time the vehicle 20 stops.

Furthermore, in the above embodiment, an example of acquiring the speed information of the vehicle 20 has been described, but it is not limited thereto. Instead of calculating the traveling speed of the vehicle 20, the moving speed of the communication device 30 may be calculated assuming that the communication device 30 is present in the vehicle 20, and the processing described above may be performed on the basis of the moving speed. Specifically, the position information of the communication device 30 is acquired on the basis of a GPS receiver provided in the communication device 30, and the speed information of the communication device 30 is acquired from a change in the position. In a case where the acceleration measurement start instruction for the acceleration sensor 306 of the communication device 30 is received and the movement of the communication device 30 stops, the calibration of the acceleration sensor 306 is executed and the calibration result is stored in response to the elapse of the first set time (for example, three seconds) in the stopped state from when the movement of the communication device 30 stops. Then, the stored calibration result is reflected in response to the elapse of the second set time (for example, five seconds) in the stopped state from when the movement of the communication device 30 is stopped. Even when such processing is performed, the same effects as those of the embodiment described above can be obtained.

### Other Embodiments

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable in such an aspect.

### Summary of Embodiments

1. The program according to the above embodiments is a program causing a computer of a communication device (30) to perform:
acquiring (S501) speed information of a vehicle (20);
receiving (S502) an acceleration measurement start instruction for an acceleration sensor (306) of the communication device;
in a case where the measurement start instruction is received and the vehicle stops, executing (S503, S504) calibration of the acceleration sensor in response to elapse of a first set time in a stopped state from when the vehicle stops;
storing (S505) a result of the calibration; and
reflecting (S506, S507) the result of the calibration stored in response to elapse of a second set time in the stopped state from when the vehicle stops.

As a result, when driving behavior is measured using the acceleration sensor of the communication device, it is possible to automatically execute the calibration of the acceleration sensor without user's consciousness. In addition, since the result of the calibration executed when the vehicle is reliably stopped can be reflected, it is possible to reduce the measurement error of the acceleration at the time of measuring the driving behavior.

2. The program according to the above embodiments, further causing the computer to perform, before the measurement start instruction is received, in a case where the vehicle stops, executing the calibration of the acceleration sensor and reflecting the calibration at a predetermined time interval.

As described above, since it is assumed that the user operates the communication device (smartphone or the like) and thus the communication device itself moves a lot before starting the measurement of the acceleration, it is possible to reduce the measurement error of the acceleration by periodically executing the calibration.

3. The program according to the above embodiments, wherein the second set time is longer than the first set time.

As a result, it is possible to reflect the result of the calibration executed when the vehicle is reliably stopped.

4. The program according to the above embodiments, further causing the computer to perform, after the measurement start instruction is received, executing the calibration once every time the vehicle stops.

As a result, calibration can be appropriately executed only once when the vehicle is reliably stopped due to waiting for a traffic signal or the like. When calibration is executed a plurality of times for each stop, there is a high possibility that the calibration is executed while the vehicle is moving. However, such a possibility can be reduced by limiting the number of times to one.

5. The program according to the above embodiments, further causing the computer to perform prioritizing completion of execution of the calibration in a case where the calibration at the predetermined time interval is being executed at a time when the measurement start instruction is received.

As a result, the calibration result can be used without any waste.

6. The program according to the above embodiments, wherein
the acquiring speed information of the vehicle includes
   receiving a GPS signal of the communication device present in the vehicle, and
   calculating speed information of the communication device based on the GPS signal and acquiring the speed information of the communication device as the speed information of the vehicle.

As a result, the moving speed of the communication device 30 that is assumed to be brought into the vehicle can be used as the traveling speed of the vehicle, and there is no need to receive information of the traveling speed of the vehicle from the vehicle or the like.

7. The program according to the above embodiments, wherein the case where the vehicle stops is a case where a speed of the vehicle reaches 0 km/h.

As a result, it is possible to accurately calculate the elapsed time in the state from when the speed of the vehicle reaches 0 km/h.

8. The program according to the above embodiments is a program causing a computer of a communication device (30) to perform:
acquiring speed information of the communication device;
receiving an acceleration measurement start instruction for an acceleration sensor (306) of the communication device;
in a case where the measurement start instruction is received and a movement of the communication device stops, executing calibration of the acceleration sensor in response to elapse of a first set time in a stopped state from when the movement of the communication device stops;
storing a result of the calibration; and
reflecting the result of the calibration stored in response to elapse of a second set time in the stopped state from when the movement of the communication device stops.

As a result, when driving behavior is measured using the acceleration sensor of the communication device, it is possible to automatically execute the calibration of the acceleration sensor without user's consciousness. In addition, since the result of the calibration executed when the movement of the communication device is reliably stopped can be reflected, it is possible to reduce the measurement error of the acceleration at the time of measuring the driving behavior.

9. The program according to the above embodiments, wherein
the acquiring speed information of the communication device includes
   receiving a GPS signal of the communication device, and
   calculating the speed information of the communication device based on the GPS signal.

As a result, the moving speed of the communication device 30 that is assumed to be brought into the vehicle can be easily calculated.

10. The storage medium according to the above embodiments is a computer readable storage medium storing the program according to the above embodiments.

As a result, the functions of the program described in the above embodiment is achievable as a storage medium.

11. The communication device according to the above embodiments is a communication device (30) comprising:
an acquisition unit (301, 303) configured to acquire speed information of a vehicle;
a reception unit (301, 305) configured to receive an acceleration measurement start instruction for an acceleration sensor (306) of the communication device;
an execution unit (301) configured to, in a case where the measurement start instruction is received and the vehicle stops, execute calibration of the acceleration sensor in response to elapse of a first set time in a stopped state from when the vehicle stops;
a storage unit (302) configured to store a result of the calibration; and
a reflection unit (301) configured to reflect the result of the calibration stored in response to elapse of a second set time in the stopped state from when the vehicle stops.

As a result, when driving behavior is measured using the acceleration sensor of the communication device, it is possible to automatically execute the calibration of the acceleration sensor without user's consciousness. In addition, since the result of the calibration executed when the vehicle is reliably stopped can be reflected, it is possible to reduce the measurement error of the acceleration at the time of measuring the driving behavior.

12. The communication device according to the above embodiments is a communication device (30) comprising:
an acquisition unit (301, 303) configured to acquire speed information of the communication device;
a reception unit (301, 305) configured to receive an acceleration measurement start instruction for an acceleration sensor (306) of the communication device;
an execution unit (301) configured to, in a case where the measurement start instruction is received and a movement of the communication device stops, execute calibration of the acceleration sensor in response to elapse of a first set time in a stopped state from when the movement of the communication device stops;
a storage unit configured to store a result of the calibration; and
a reflection unit configured to reflect the result of the calibration stored in response to elapse of a second set time in the stopped state from when the movement of the communication device stops.

As a result, when driving behavior is measured using the acceleration sensor of the communication device, it is possible to automatically execute the calibration of the acceleration sensor without user's consciousness. In addition, since the result of the calibration executed when the movement of the communication device is reliably stopped can be reflected, it is possible to reduce the measurement error of the acceleration at the time of measuring the driving behavior.

13. The method of controlling a communication device according to the above embodiments is a method of controlling a communication device (30), comprising:
acquiring speed information of a vehicle (20);
receiving an acceleration measurement start instruction for an acceleration sensor (306) of the communication device;
in a case where the measurement start instruction is received and the vehicle stops, executing calibration of the acceleration sensor in response to elapse of a first set time in a stopped state from when the vehicle stops;
storing a result of the calibration; and
reflecting the result of the calibration stored in response to elapse of a second set time in the stopped state from when the vehicle stops.

As a result, when driving behavior is measured using the acceleration sensor of the communication device, it is possible to automatically execute the calibration of the acceleration sensor without user's consciousness. In addition, since the result of the calibration executed when the vehicle is reliably stopped can be reflected, it is possible to reduce the measurement error of the acceleration at the time of measuring the driving behavior.

14. The method of controlling a communication device according to the above embodiments is a method of controlling a communication device (30), comprising:
acquiring speed information of the communication device;
receiving an acceleration measurement start instruction for an acceleration sensor (306) of the communication device;
in a case where the measurement start instruction is received and a movement of the communication device stops, executing calibration of the acceleration sensor in response to elapse of a first set time in a stopped state from when the movement of the communication device stops;
storing a result of the calibration; and
reflecting the result of the calibration stored in response to elapse of a second set time in the stopped state from when the movement of the communication device stops.

As a result, when driving behavior is measured using the acceleration sensor of the communication device, it is possible to automatically execute the calibration of the acceleration sensor without user's consciousness. In addition, since the result of the calibration executed when the movement of the communication device is reliably stopped can be reflected, it is possible to reduce the measurement error of the acceleration at the time of measuring the driving behavior.

According to the present invention, when driving behavior is measured using the acceleration sensor of the communication device, it is possible to automatically execute the calibration of the acceleration sensor without user's consciousness.

The invention is not limited to the foregoing embodiments, and various variations/changes are possible within the spirit of the invention.

What is claimed is:

1. A non-transitory computer-readable storage medium storing a program causing
a computer of a communication device to perform:
acquiring speed information of a vehicle;
receiving an acceleration measurement start instruction for an acceleration sensor of the communication device;
in a case where the measurement start instruction is received and the vehicle stops, executing calibration of the acceleration sensor in response to elapse of a first set time in a stopped state from when the vehicle stops;
storing a result of the calibration; and
reflecting the result of the calibration stored in response to elapse of a second set time in the stopped state from when the vehicle stops.

2. The non-transitory computer-readable storage medium according to claim 1, further causing the computer to perform, before the measurement start instruction is received, in a case where the vehicle stops, executing the calibration of the acceleration sensor and reflecting the calibration at a predetermined time interval.

3. The non-transitory computer-readable storage medium according to claim 1, wherein the second set time is longer than the first set time.

4. The non-transitory computer-readable storage medium according to claim 1, further causing the computer to perform, after the measurement start instruction is received, executing the calibration once every time the vehicle stops.

5. The non-transitory computer-readable storage medium according to claim 2, further causing the computer to perform prioritizing completion of execution of the calibration in a case where the calibration at the predetermined time interval is being executed at a time when the measurement start instruction is received.

6. The non-transitory computer-readable storage medium according to claim 1, wherein
the acquiring speed information of the vehicle includes
receiving a GPS signal of the communication device present in the vehicle, and
calculating speed information of the communication device based on the GPS signal and acquiring the speed information of the communication device as the speed information of the vehicle.

7. The non-transitory computer-readable storage medium according to claim 1, wherein the case where the vehicle stops is a case where a speed of the vehicle reaches 0 km/h.

8. A non-transitory computer-readable storage medium storing a program causing a computer of a communication device to perform:
acquiring speed information of the communication device;
receiving an acceleration measurement start instruction for an acceleration sensor of the communication device;
in a case where the measurement start instruction is received and a movement of the communication device stops, executing calibration of the acceleration sensor in response to elapse of a first set time in a stopped state from when the movement of the communication device stops;
storing a result of the calibration; and
reflecting the result of the calibration stored in response to elapse of a second set time in the stopped state from when the movement of the communication device stops.

9. The non-transitory computer-readable storage medium according to claim 8, wherein
the acquiring speed information of the communication device includes
receiving a GPS signal of the communication device, and
calculating the speed information of the communication device based on the GPS signal.

10. A communication device comprising:
an acquisition unit configured to acquire speed information of a vehicle;
a reception unit configured to receive an acceleration measurement start instruction for an acceleration sensor of the communication device;
an execution unit configured to, in a case where the measurement start instruction is received and the vehicle stops, execute calibration of the acceleration sensor in response to elapse of a first set time in a stopped state from when the vehicle stops;
a storage unit configured to store a result of the calibration; and
a reflection unit configured to reflect the result of the calibration stored in response to elapse of a second set time in the stopped state from when the vehicle stops.

11. A communication device comprising:
an acquisition unit configured to acquire speed information of the communication device;
a reception unit configured to receive an acceleration measurement start instruction for an acceleration sensor of the communication device;
an execution unit configured to, in a case where the measurement start instruction is received and a movement of the communication device stops, execute calibration of the acceleration sensor in response to elapse of a first set time in a stopped state from when the movement of the communication device stops;
a storage unit configured to store a result of the calibration; and
a reflection unit configured to reflect the result of the calibration stored in response to elapse of a second set time in the stopped state from when the movement of the communication device stops.

12. A method of controlling a communication device, comprising:
acquiring speed information of a vehicle;
receiving an acceleration measurement start instruction for an acceleration sensor of the communication device;
in a case where the measurement start instruction is received and the vehicle stops, executing calibration of the acceleration sensor in response to elapse of a first set time in a stopped state from when the vehicle stops;
storing a result of the calibration; and
reflecting the result of the calibration stored in response to elapse of a second set time in the stopped state from when the vehicle stops.

13. A method of controlling a communication device, comprising:
acquiring speed information of the communication device;
receiving an acceleration measurement start instruction for an acceleration sensor of the communication device;
in a case where the measurement start instruction is received and a movement of the communication device stops, executing calibration of the acceleration sensor in response to elapse of a first set time in a stopped state from when the movement of the communication device stops;
storing a result of the calibration; and
reflecting the result of the calibration stored in response to elapse of a second set time in the stopped state from when the movement of the communication device stops.
